(19) United States
(12) Patent Application Publication
(10) Pub. No.: US 2011/0188057 A1
(43) Pub. Date: Aug. 4, 2011

(54) INFORMATION PROCESSING APPARATUS, METHOD FOR CONTROLLING INFORMATION PROCESSING APPARATUS, AND STORAGE MEDIUM

(75) Inventor: Masakatsu Sakurai, Toride-shi (JP)

(73) Assignee: CANON KABUSHIKI KAISHA, Tokyo (JP)

(21) Appl. No.: 13/008,220

(22) Filed: Jan. 18, 2011

(30) Foreign Application Priority Data
Jan. 29, 2010 (JP) 2010-018437

(51) Int. Cl. G06K 15/02

(52) U.S. Cl. 358/1.2

(57) ABSTRACT

A processor divides objects laid out on a page into a plurality of blocks, and extracts a table block from the plurality of blocks. Then, for the table block, the processor executes margin reduction processing for reducing the blank portion between objects included in the table block.

### BACKGROUND OF THE INVENTION

1. Field of the Invention

The present invention relates to an information processing apparatus, a method for controlling the information processing apparatus, and storage medium.

2. Description of the Related Art

There are needs to execute energy-saving printing by reducing the number of papers printed as much as possible when printing print data. As a technique for performing such energy-saving printing, there has been proposed a system in which, when printing is performed, a blank portion between drawing objects is detected to perform margin reduction processing for reducing the blank portion before performing print processing to thereby reduce the number of papers to be output for printing. For example, Japanese Patent Laid-Open No. 2006-48520 discloses an image processing system in which a PDL (Page Description Language) analysis is performed for input data to determine the attributes of characters, figures, and blanks to thereby separate them into block units for each object. Also, the image processing system reduces an object to be moved depending on a pre-set priority and then moves the reduced object within the newly-generated blank portion. Then, the image processing system deletes the blank portion, which has been generated on data after movement of the reduced object, to thereby perform an automatic change in print layout.

However, in the image processing system disclosed in Japanese Patent Laid-Open No. 2006-48520, margin reduction processing for a blank portion is performed by moving objects in block units, but margin reduction processing is not executed for a blank portion that is present within a block. Thus, even when a blank portion is present within a table block, which is a block corresponding to a table surrounded by, for example, a ruled line, the image processing system cannot reduce the blank portion.

FIGS. 16A to 16C are diagrams illustrating the problems when margin reduction processing is performed by the image processing system disclosed in Japanese Patent Laid-Open No. 2006-48520. FIG. 16A shows a predetermined page. First, the objects within a page shown in FIG. 16A are divided into three blocks B1, B2, and B3 as shown in FIG. 16B. The block B1 is a block including a character string object and an image object. The block B2 is a table block including a ruled line object and objects included within the table surrounded by the ruled line. The block B3 is a block including a character string object. Then, as a result of reducing the blank between adjacent blocks, the blank portion between the blocks B1 and B2 and the blank portion between the blocks B2 and B3 are reduced as shown in FIG. 16C. However, the blank portions, which are present between the objects within the table block B2, remain. Thus, the blank portions within the table block may cause the output of unwanted papers.

### SUMMARY OF THE INVENTION

The present invention provides an information processing apparatus that reduces a blank portion in a table block obtained from a page and that is thereby capable of reducing unwanted prints.

According to an aspect of the present invention, an information processing apparatus is provided that includes a division unit configured to divide objects laid out on a page into a plurality of blocks; an extraction unit configured to extract a table block including a ruled line object from the plurality of blocks; and a margin reduction unit configured to detect a blank portion between objects included in the extracted table block and execute margin reduction processing for reducing the detected blank portion.

Further features of the present invention will become apparent from the following description of exemplary embodiments with reference to the attached drawings.

### BRIEF DESCRIPTION OF THE DRAWINGS

FIG. 1 is a diagram illustrating an example of the system configuration of the present embodiment.

FIG. 2 is a diagram illustrating an example of an object list.

FIGS. 3A and 3B are diagrams illustrating object information and an example of object arrangement.

FIGS. 4A and 4B are diagrams illustrating object information.

FIG. 5 is a diagram illustrating an example of the operation processing flow of the information processing apparatus of the present embodiment.

FIG. 6 is a diagram illustrating an example of a margin reduction setting screen.

FIG. 7 is a diagram illustrating margin reduction processing within a page area.

FIGS. 8A to 8H are diagrams illustrating an example of margin reduction processing within a table block.

FIGS. 9A to 9C are diagrams illustrating an example of the process of calculating the margin reduction positions and the margin reduction amounts.

FIG. 10 is a diagram illustrating an example of the flow of margin reduction processing within a table block.

FIG. 11 is a diagram illustrating margin reduction processing according to the correction value.

FIGS. 12A to 12C are diagrams illustrating margin reduction processing according to the correction value.

FIG. 13 is a diagram illustrating margin reduction processing for the entire page.

FIGS. 14A to 14D are diagrams illustrating modification of a table block and margin reduction processing for the entire blocks.

FIG. 15 is a diagram illustrating margin reduction processing between pages.

FIGS. 16A to 16C are diagrams illustrating the problems that occur when margin reduction processing is performed.

### DESCRIPTION OF THE EMBODIMENTS

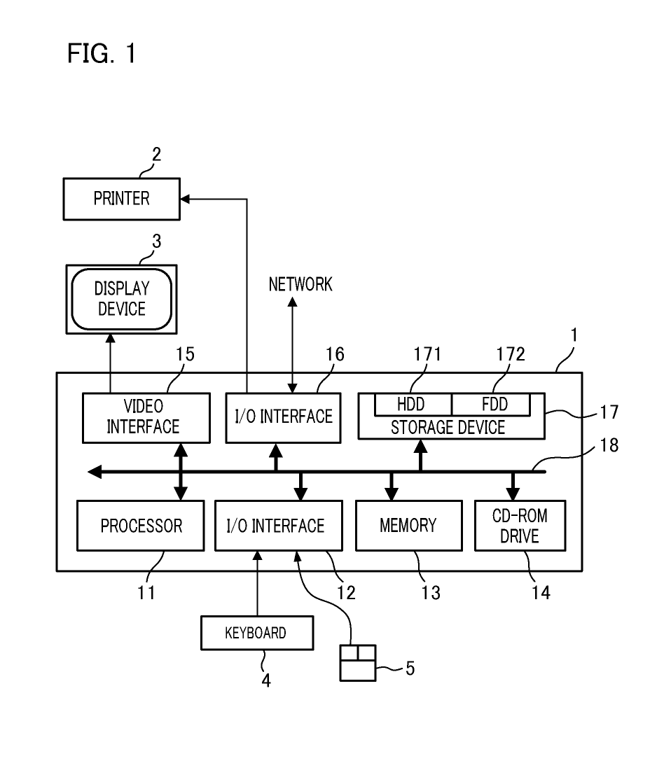

FIG. 1 is a diagram illustrating an example of the system configuration of the present embodiment. The system shown in FIG. 1 includes a computer 1, a printer 2, and a display device 3. The computer 1 is the information processing apparatus of the present embodiment. The computer 1 executes margin reduction processing for the target page. Margin reduction processing is processing for reducing the margin of a blank portion included in the target page. Also, the computer 1 transmits the print data of the target page, which has undergone the aforementioned margin reduction processing, to the printer 2 to cause it to print the print data. Further, the computer 1 transmits various display data to the display device 3 to cause it to display the display data. In the present embodiment, the target page is data including objects laid out on a page, such as, for example, PDF (Portable Document Format) or the like. The printer 2 prints the print data in accordance with the instruction from the computer 1. The display device 3 displays the display data in accordance with the instruction from the computer 1. A keyboard 4 and a mouse 5 are devices that input information depending on the operation input by a user of the computer 1.

The computer 1 includes a processor 11, I/O (Input/Output) interfaces 12 and 16, and a memory 13. The computer 1 further includes a CD-ROM (Compact Disk Read Only Memory) drive 14, a video interface 15, and a storage device 17. The processor 11 controls the overall computer 1. The processor 11 is, for example, a CPU (Central Processing Unit). As the operation specific to the present embodiment, the processor 11 functions as a division unit configured to divide objects laid out on a page into a plurality of blocks. The processor 11 analyzes the target page. The result of analysis of the target page includes, for example, an object list. The object list is a list of the object information included in the target page. The object information includes, for example, object identification information, object attributes, and object coordinate information. The processor 11 stores the object list in the storage device 17.

The processor 11 generates, for example, circumscribed rectangles with respect to the respective objects on the page, and extracts a plurality of rectangles where the Y-coordinates overlap from among the generated circumscribed rectangles. Then, the processor 11 generates a circumscribed rectangle that surrounds the plurality of extracted rectangles to thereby generate a single block. With this arrangement, a plurality of rectangle blocks, which do not overlap in the Y-axis direction, is generated. The processor 11 stores the information for the respective blocks obtained by division in the storage device 17. The block information stored in the storage device 17 includes, for example, block identification information, block attribute, block coordinate information, and the identification information for the objects included in the blocks. The block attribute indicates whether a block is a table block or a block other than a table block. Note that in the present application, a block including a ruled line object is identified as a table block. The processor 11 searches an object list using the identification information for the objects included in the blocks to thereby be able to acquire the information for the objects included in the respective blocks.

Also, the processor 11 functions as a block extraction unit configured to extract a table block including a ruled line object from the plurality of blocks. Further, the processor 11 functions as a margin reduction unit configured to detect a blank portion between objects included in the extracted table block and execute margin reduction processing for reducing the detected blank portion.

The I/O interface 12 inputs the information, which has been input by the keyboard 4 and the mouse 5, to the computer 1. An I/O interface 16 mediates the transmission of print data from the computer 1 to the printer 2. Further, the I/O interface 16 communicates with external devices through a network. An exemplary network includes LAN (Local Area Network), WAN (Wide Area Network), or the like.

The memory 13 is a storage unit including RAM (Random Access Memory) and ROM (Read Only Memory). The RAM includes the working area for use in processing by the processor 11. The program and data for use in controlling the computer 1 by the processor 11 are stored in the ROM in advance. The CD-ROM drive 14 is a device in which a CD-ROM, i.e., a non-volatile storage medium, is stored. The video interface 15 mediates the transmission of display data from the computer 1 to the display device 3. The storage device 17 stores the information for, for example, a page, an object list, and a block. In the example shown in FIG. 1, the storage device 17 includes a HDD (Hard Disk Drive) and a FDD. The term “FDD” is the abbreviation for “Floppy (registered trademark) Disk Drive”. A method for controlling the information processing apparatus of the present embodiment and its computer program are realized by the functions of the processing sections provided in the computer shown in FIG. 1.

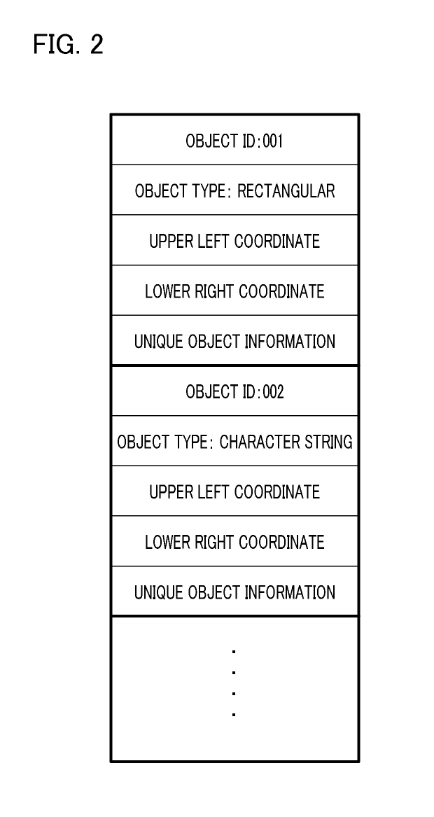

FIG. 2 is a diagram illustrating an example of an object list. The object information included in the object list includes an object ID, an object type, an upper-left coordinate, a lower-right coordinate, and unique object information. The object ID denotes the identification information for identifying an object. The object type denotes the type of an object. For example, a “rectangular” included in the object information denotes that the object is a rectangular object, and a “character string” denotes that the object is a character string object. The unique object information is information that is unique for each object. In the example shown in FIG. 2, although a single character string object corresponds to a plurality of character strings, a character string object corresponding to a single character string is also included in the object list. Also, in the example shown in FIG. 2, although the object list includes a rectangular object having four ruled line object, the information for each ruled line object is also included in the object list. The ruled line object is an object for a ruled line. When the object is a ruled line object, the object information includes the object ID, the object type of “ruled line”, the unique object information about, for example, a line thickness and a line type. In addition, the object information includes the coordinate information for the ruled line. When the object is a character string object, the unique object information is, for example, a font type or a size of a character. The object type and unique object information included in the object list denote object attributes.

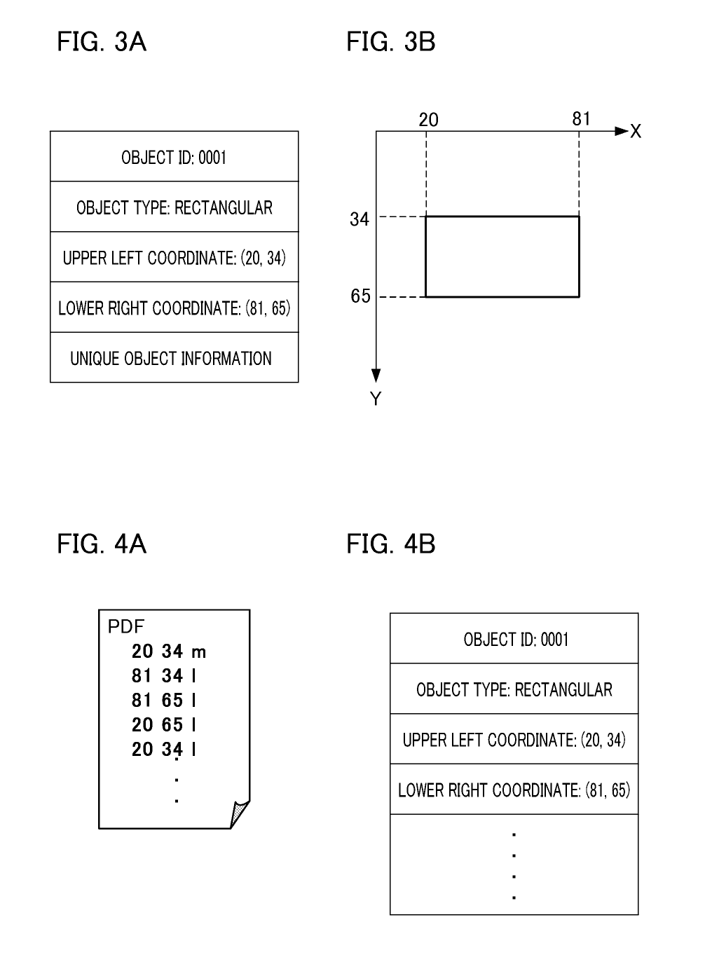

FIG. 3 is a diagram illustrating object information and an example of object arrangement. The object indicated by the object information shown in FIG. 3A corresponds to a rectangular laid out at the position shown in FIG. 3B in a predetermined page.

FIG. 4 is a diagram illustrating object information obtained from the result of analysis of a PDF formatted page. The computer 1 analyzes, for example, the PDF shown in FIG. 4A to thereby acquire the object information shown in FIG. 4B.

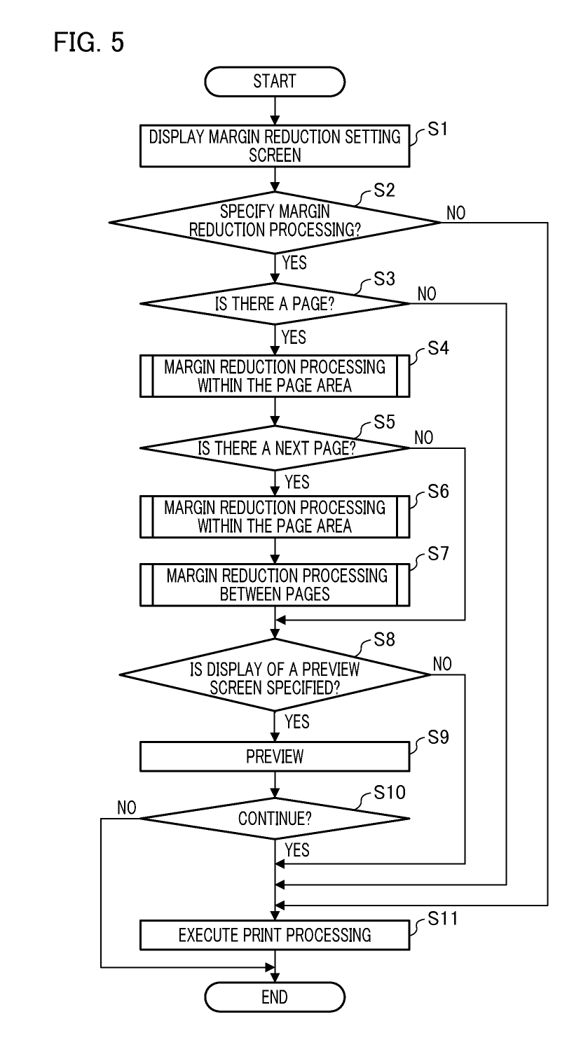

FIG. 5 is a diagram illustrating an example of the operation processing flow of the information processing apparatus of the present embodiment. Note that the flowchart of the present application is realized by the fact that the processor 11 provided in the computer 1 reads and executes the program associated with the processing shown in the flowchart. First, the processor 11 provides an instruction to the display device 3 upon start of print processing for the target page and displays a margin reduction setting screen (step S1). The margin reduction setting screen is a screen for specifying margin reduction processing (margin reduction printing) by a user.

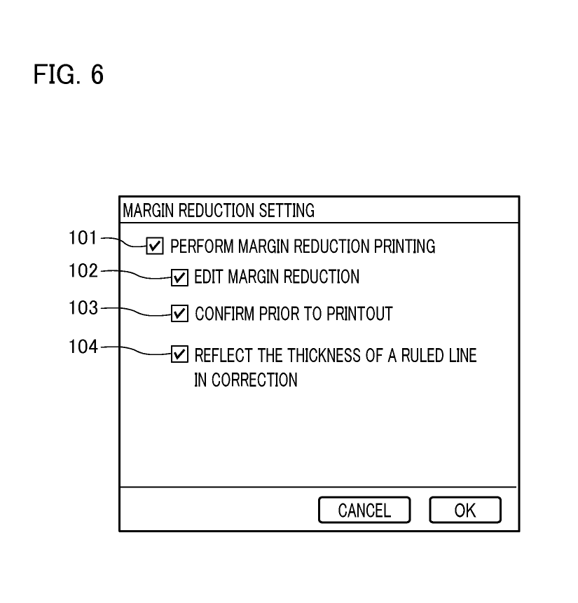

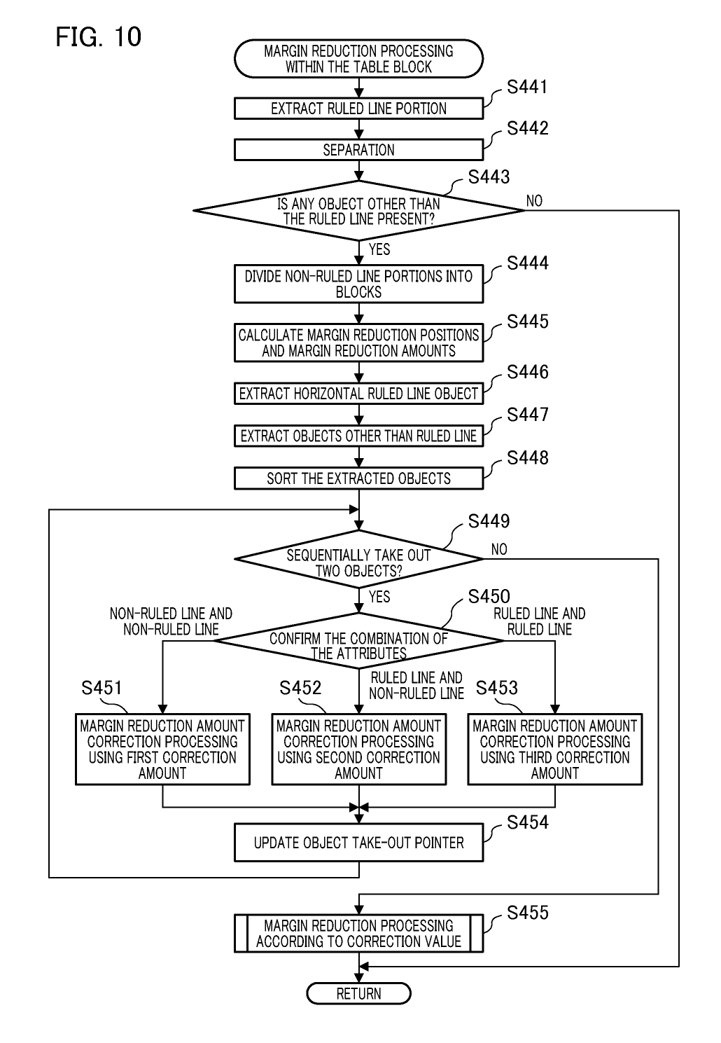

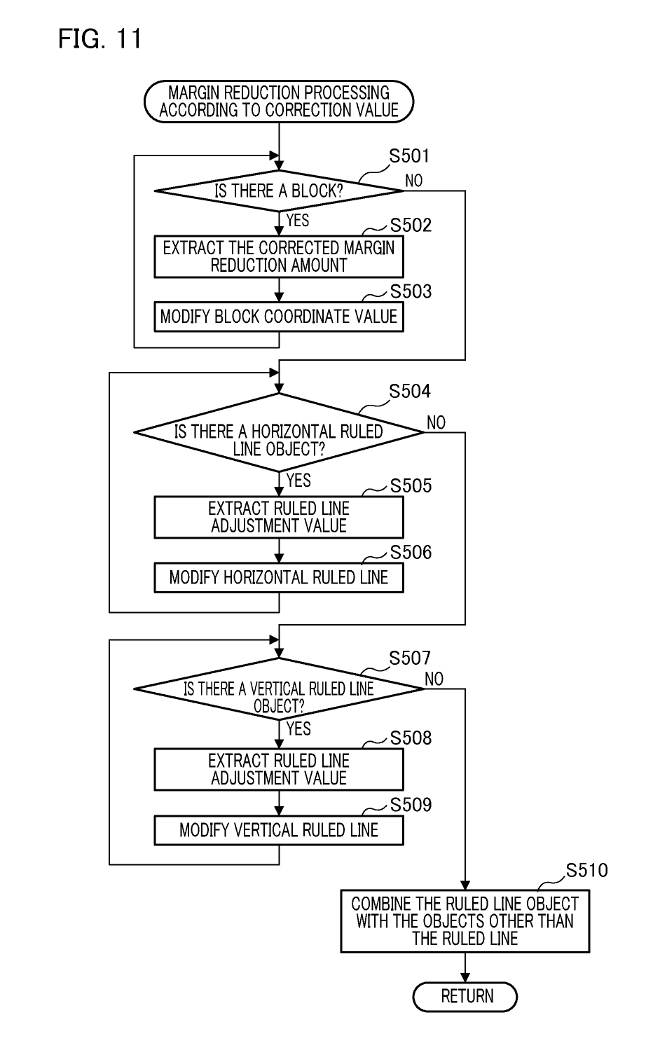

FIG. 6 is a diagram illustrating an example of a margin reduction setting screen. Margin reduction processing is processing for reducing the blank portion included in a page to a predetermined size. When a user checks a setting column 101 and turns it ON, margin reduction processing is specified. When a user checks a setting column 102 and turns it ON, margin reduction editing is specified. The margin reduction editing is an editing of the processes executed by margin reduction processing. When the margin reduction editing is specified, the processor 11 displays an edit screen for editing the processes executed by margin reduction processing. Through the edit screen, a user can perform, for example, the selection of the block(s) to be processed and the adjustment of the margin reduction amount. When a user checks a setting column 103 and turns it ON, displaying a preview screen is specified. To specify the display for a preview screen is to preview the result of margin reduction processing. When the display of a preview screen is specified, the processor 11 displays the result of margin reduction processing before print processing for print data. With this arrangement, a user can confirm whether or not to continue margin reduction processing. When a user checks a setting column 104 and turns it ON, the processor 11 reflects the thickness of a ruled line in the correction value for the margin reduction during margin reduction processing. The correction value for the margin reduction is a value for correcting the margin reduction amount that is determined based on the coordinate of an object. The correction value for the margin reduction, in which the thickness of a ruled line has been reflected, is employed, for example, in step S452 or step S453 shown in FIG. 10 to be described below. Also, the setting screen shown in FIG. 6 may receive the predetermined size of the blank portion obtained by margin reduction processing. Here, for example, when the size “1 cm” is received as a predetermined size, a processor executes margin reduction processing until the distance between blocks becomes “1 cm”.

Referring back to FIG. 5, the processor 11 determines whether or not margin reduction processing has been specified (step S2). When the processor 11 determines that margin reduction processing has not been specified, the process advances to step S11. On the other hand, when the processor 11 determines that margin reduction processing has been specified, the processor 11 acquires a document to be printed from the storage device 17, and determines the presence/absence of the page, in which margin reduction processing has not been executed, from the acquired document (step S3). Note that for a page on which the process in step S4, to be described below, has been executed, a finish flag for margin reduction processing is set. Accordingly, the process in step S3 is executed according to the finish flag. When the processor 11 determines that there is a page in which margin reduction processing has not been executed, the processor 11 extracts the page data for the page on which margin reduction processing has not been executed from the document, and executes margin reduction processing within the page area (step S4). Note that page data is data for the target page.

Next, the processor 11 determines the presence/absence of a next page following the page in which margin reduction processing has been executed in step S4 (step S5). When the processor 11 determines that a next page is absent, the process advances to step S8. On the other hand, when the processor 11 determines that a next page is present, the processor 11 executes margin reduction processing within the page area of the next page (step S6).

Next, the processor 11 executes margin reduction processing between pages (step S7). The processes in steps S3 to S7 are executed for all pages of the document. Next, the processor 11 determines whether or not the display of a preview screen has been specified (step S8). When the processor 11 determines that the display of a preview screen has not been specified, the process advances to step S11. On the other hand, when the processor 11 determines that the display of a preview screen has been specified, the processor 11 previews the result of margin reduction processing (step S9).

Next, the processor 11 displays a screen inquiring a user about whether or not print processing is to be continued. Then, the processor 11 determines whether or not print processing is to be continued based on the user's operation input depending on the inquiry (step S10). When the processor 11 determines that print processing is not continued, the process is ended. On the other hand, when the processor 11 determines that print processing is continued, the processor 11 transmits the print data that has undergone margin reduction processing to the printer 2 to thereby execute print processing (step S11).

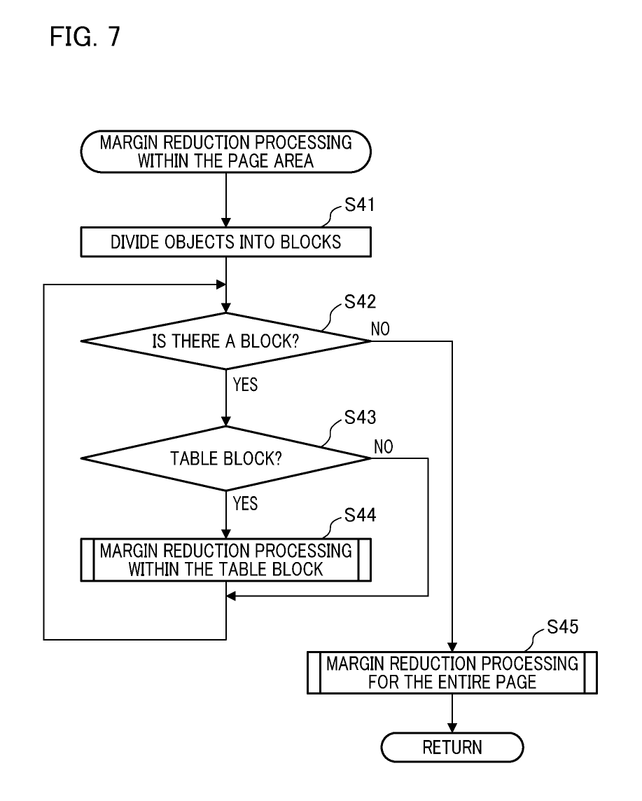

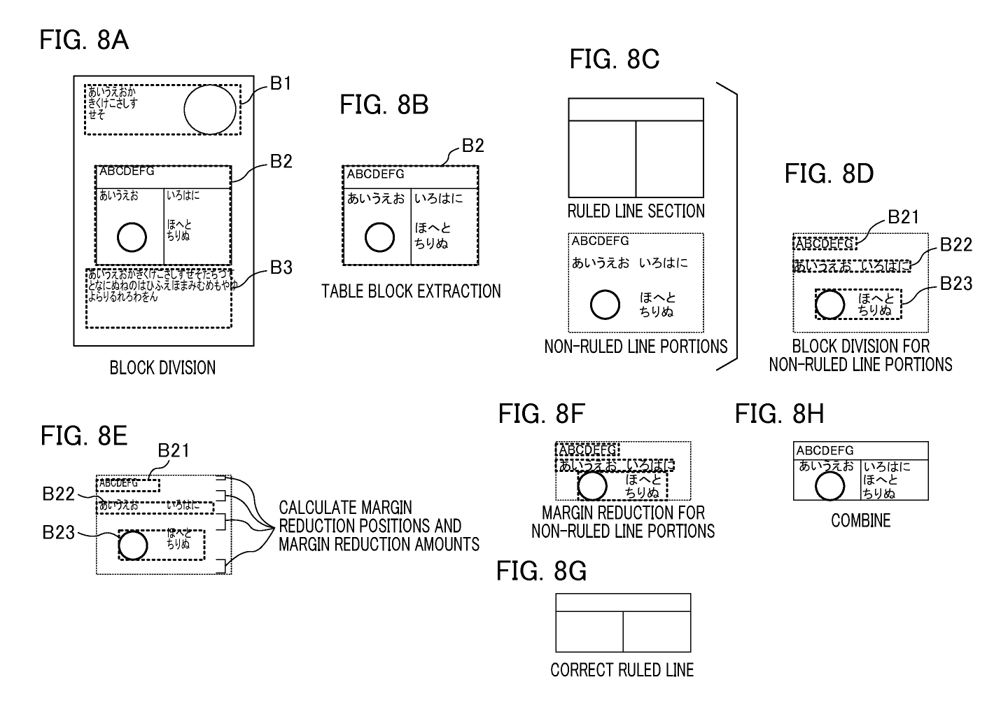

FIG. 7 is a diagram illustrating margin reduction processing within the page area, which is performed in step S4 or step S6 shown in FIG. 5. First, the processor 11 divides objects included in page data into blocks (step S41). For example, as shown in FIG. 8A, the processor 11 divides the object included in the page data into three blocks B1 to B3. For example, in the block B1, since the Y-coordinate of the circumscribed rectangle of the character object “ [symbol] . . . ” and the Y-coordinate of the circular object overlap with each other, both objects are included in the same block. The Y-coordinate block processing is executed for each object to thereby obtain FIG. 8A. Next, the processor 11 determines whether or not there is a block to be processed (step S42). When the processor 11 determines that there is no block to be processed, the processor 11 executes margin reduction processing for the entire page (step S45). Note that for the block in which margin reduction processing within a table block has been executed in step S44, to be described below, a finish flag is set. Thus, the process in step S42 is executed in accordance with the finish flag.

When the processor 11 determines that there is a block to be processed, the processor 11 extracts the block and determines whether or not the extracted block is a table block, in other words, a block including a ruled line object (step S43). When the processor 11 determines that the extracted block is not a table block, the process returns to step S42. On the other hand, when the processor 11 determines that the extracted block is a table block, the processor 11 executes margin reduction processing within the table block (step S44).

FIGS. 8A to 8H are diagrams illustrating an example of margin reduction processing within a table block, which is performed in step S44 shown in FIG. 7. The block B2 shown in FIG. 8B denotes a table block that has been extracted from the divided blocks. First, as shown in FIG. 8C, the processor 11 extracts a ruled line portion from the table block B2, and separates the table block B2 into the ruled line portion and the portion other than the ruled line portion. Next, the processor 11 divides the portion other than the ruled line portion into blocks. With this arrangement, as shown in FIG. 8D, the portion other than the ruled line portion is divided into three blocks, for example, B21 to B23. Note that the block division processing is the same as that in step S41 shown in FIG. 7. For a table block, the information processing apparatus of the present embodiment manages the blocks included in the table block as a single object in the object list. Thus, the blocks included in the table block denote objects that are included in the portion other than the ruled line portion.

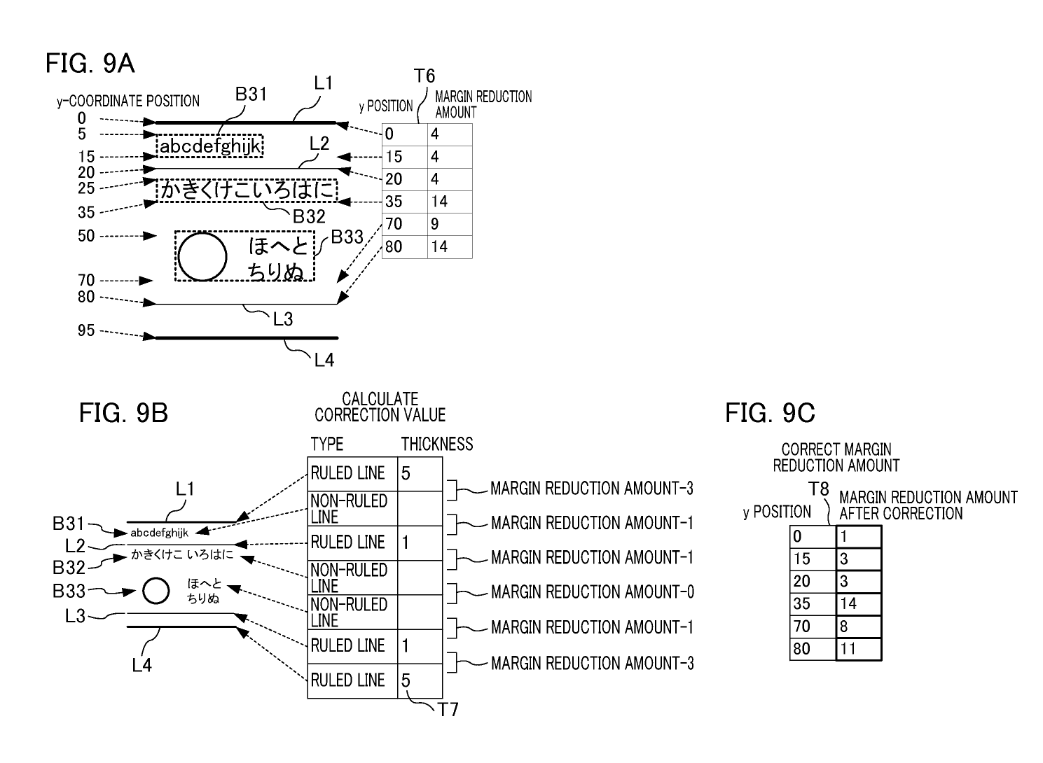

Next, as shown in FIG. 8E, the processor 11 calculates the margin reduction positions and the margin reduction amount corresponding to each margin reduction position. More specifically, the margin reduction position is the Y-coordinates of the upper left and the lower left of each block and the Y-coordinate of the ruled line. Next, a method for calculating a margin reduction amount will now be described. In a memory, a predetermined blank size obtained by execution of margin reduction processing is determined (e.g., reducing the margin, i.e., the distance between blocks to “1”). Then, the difference between the distance between current blocks and a predetermined blank size becomes the margin reduction amount. For example, in FIG. 8E, when the blank between the lower end of B21 and the upper end of B22 is 5 and a predetermined blank size is 1, the margin reduction amount is 4. Note that the details of the process of calculating the margin reduction amount will be described below with reference to FIG. 9A to 9C.

Subsequently, as shown in FIG. 8F, the processor 11 executes margin reduction processing for reducing the blank portion between the objects other than the ruled line object based on the margin reduction positions and the margin reduction amounts which have been calculated. More specifically, the processor 11 reduces the blank portion between blocks by moving each of the blocks B21 to B23 shown in FIG. 8E from the margin reduction position of each block in a direction along the Y-axis by a distance corresponding to the margin reduction amount. The processor 11 updates the object information corresponding to the moved blocks (object coordinate information) in the object list. Also, as shown in FIG. 8G, the processor 11 corrects the ruled line indicated by the ruled line object included in the ruled line portion shown in FIG. 8C based on the margin reduction positions and the margin reduction amounts which have been calculated (i.e., the margin reduction processing result about the objects other than the ruled line object). The processor 11 updates the object information corresponding to the corrected ruled line (the coordinate information for the ruled line) in the object list. Then, as shown in FIG. 8H, the processor 11 combines the portions, which have undergone margin reduction processing, other than the ruled line portion (see FIG. 8F) with the ruled line portion in which the ruled line has been corrected (see FIG. 8G).

As described with reference to FIG. 8A to 8H, the information processing apparatus of the present embodiment separates the ruled line portion and the non-ruled line portions from a table block, performs margin reduction processing for the non-ruled line portions, and corrects the ruled line portion based on the margin reduction positions and the margin reduction amounts which have been used for margin reduction processing. Then, the information processing apparatus of the present embodiment combines the corrected ruled line portion with the non-ruled line portions that have undergone margin reduction processing to thereby perform margin reduction processing for all tables. Thus, according to the information processing apparatus of the present embodiment, margin reduction processing can be executed even for a block surrounded by a ruled line, whereby unwanted prints can be reduced.

FIGS. 9A to 9C are diagrams illustrating an example of the process of calculating the margin reduction positions and the margin reduction amounts. Note that in the following description, FIG. 9A is a diagram illustrating objects laid out within a page. The reference numerals B31 to B33 shown in FIG. 9A are blocks (objects) obtained by the block division of the portion other than the ruled line portion, which is performed by the processor 11. Also, the reference numerals L1 to L4 denote ruled lines indicated by the ruled line object included in the ruled line portion. In the present embodiment, the processor 11 calculates the margin reduction positions and the margin reduction amounts based on the coordinates of each object.

First, the processor 11 determines the Y-coordinates of the upper left and the lower left of the blocks as the margin reduction positions. Also, the processor 11 determines the Y-coordinates of the ruled lines as the margin reduction positions. More specifically, the processor 11 determines the positions: the Y-coordinate “0” of the ruled line L1, the Y-coordinate “5, 15” of the block B31, the Y-coordinate “20” of the ruled line L2, the Y-coordinate “25, 35” of the block B32, the Y-coordinate “50, 70” of the block B33, and the Y-coordinate “80” of the ruled line L3 as the margin reduction positions. Also, the processor 11 calculates the blank amount between blocks using the margin reduction positions. For example, the processor 11 calculates the blank amount “5” based on the Y-coordinate of the ruled line L1 and the Y-coordinate of the upper end of the block B31 adjacent to the ruled line L1. When a predetermined blank size obtained by execution of margin reduction processing is set, for example, to “1”, the blank amount between the ruled lines L1 and B31 needs to be reduced by “4” in order to reduce the blank amount “5” therebetween to a predetermined blank size “1”. Thus, the processor 11 calculates the margin reduction amount “4” as the margin reduction amount for reducing the blank between the ruled line L1 and the block B31, and sets the margin reduction amount as the margin reduction amount corresponding to the margin reduction position at the Y-coordinate “0”. Likewise, since the blank amount between the block B31 and the ruled line L2 is “5”, the processor 11 calculates the margin reduction amount “4” as the margin reduction amount for reducing the blank between the block B31 and the ruled line L2, and sets the margin reduction amount as the margin reduction amount corresponding to the margin reduction position at the Y-coordinate “15”. Also, since the blank amount between the ruled line L2 and the block B32 is “5”, the processor 11 calculates the margin reduction amount “4” as the margin reduction amount for reducing the blank between the ruled line L2 and the block B32. Then, the processor 11 sets the margin reduction amount as the margin reduction amount corresponding to the margin reduction position at the Y-coordinate “20”. This process is executed between blocks.

By executing the aforementioned processing between blocks, the table T6 shown in FIG. 9A is obtained. The table T6 indicates the margin reduction amounts corresponding to the respective margin reduction positions. The processor 11 moves the blocks based on the margin reduction positions and the margin reduction amounts that have been obtained. More specifically, since the margin reduction amount for reducing the blank between the ruled line L1 and the block B31 is “4” and the Y-coordinate of the upper end of the block B31 is “5”, the Y-coordinate of the block B31 is changed to “1” by execution of margin reduction processing. Subsequently, the processor 11 calculates the Y-coordinate of the ruled line L2, which has been obtained by execution of margin reduction processing. Note that, in order to calculate the Y-coordinate of the ruled line L2, the amount of movement of the object to which margin reduction processing has already been executed also needs to be taken into consideration. In other words, the margin reduction amount for reducing the blank between the block B31 and the ruled line L2 is “4”, the amount of movement of the block B31, to which margin reduction processing has already been executed, is “4”, and the margin reduction position corresponding to the ruled line L2 is “20”. Thus, the Y-coordinate of the ruled line L2 is changed to “12” by execution of margin reduction processing.

Furthermore, the processor 11 calculates the Y-coordinate of the upper end of the block B32, which has been obtained by execution of margin reduction processing. The margin reduction amount for reducing the blank between the ruled line L2 and the block B32 is “4”, the sum of the amount of movement of the block B31, to which margin reduction processing has already been executed, and the amount of movement of the ruled line L2 is “8”, and the Y-coordinate of the upper end of the block B32 is “25”. Thus, by execution of margin reduction processing, the Y-coordinate of the upper end of the block B32 is changed to “13”. By executing the aforementioned processing, margin reduction processing within the page area is executed. Consequently, for example, the positions of the blocks and the ruled lines shown in FIG. 9A are changed to the positions of the blocks B31 to B33 and the ruled lines L1 to L4 shown in FIG. 9B.

An example of margin reduction processing within a table block will be described with reference to FIGS. 10 to 12C. FIG. 10 is a diagram illustrating an example of the flow of margin reduction processing within a table block. First, the processor 11 extracts the ruled line portion from a table block (step S441). Next, the processor 11 separates the table block into the ruled line portion and the portion other than the ruled line portion (step S442). Subsequently, the processor 11 determines whether or not any object other than the ruled line object is present in the block to be processed (step S443). A determination whether or not the ruled line object is present is executed by using the object type shown in FIG. 2. When the processor 11 determines that there is no objects other than the ruled line object, the process returns to step S42 shown in FIG. 7. When the processor 11 determines that there is an object other than the ruled line object, the processor 11 divides the objects other than the ruled line portion into blocks (step S444). Note that, in the following description, FIG. 9A is a diagram illustrating the object laid out within the table block. By the process in step S444, the portion other than the ruled line portion in the table block is divided into the blocks B31 to B33 as shown in FIG. 9A.

Next, the processor 11 calculates the margin reduction positions and the margin reduction amounts for the portion other than the ruled line portion (step S445). In step S445, the processor 11 further generates, for example, the table T6 shown in FIG. 9A using the margin reduction positions and the margin reduction amounts which have been calculated. Subsequently, the processor 11 extracts a horizontal ruled line object (step S446). The horizontal ruled line object is an object indicating a horizontal ruled line. The processor 11 extracts, for example, the ruled lines L1 to L4 shown in FIG. 9A. Also, the processor 11 extracts the objects other than the ruled line (step S447). The processor 11 extracts, for example, the blocks B31 to B33 shown in FIG. 9A.

Next, the processor 11 sorts the objects in the ascending order of the Y-coordinates of the positions of the extracted objects such that the Y-coordinate values are in an ascending order (step S448). Then, the processor 11 sequentially takes out two objects that are adjacent to each other (step S449). When the processor 11 cannot take out two adjacent objects, the process advances to step S455, and margin reduction processing according to the correction value is performed. On the other hand, when the processor 11 can take out two adjacent objects, the processor 11 confirms the combination of the attributes of the taken-out objects with reference to the object list (step S450). When the combination of the attributes of the objects is a non-ruled line and a non-ruled line, the processor 11 performs margin reduction amount correction processing using a first correction amount (step S451). When the combination of the attributes of the objects is a non-ruled line and a non-ruled line, the first correction amount is applied to margin reduction processing for reducing the blank portion between these objects. The first correction amount is determined in advance, as shown in the table T7 of FIG. 9B, for example (the same applies to a second correction amount and a third correction amount to be described below). Here, assume the case where the objects to be processed are the blocks B32 and B33 shown in FIG. 9A. In this case, when referring to the table T7, it is found that the first correction amount is “0”. On the other hand, when referring to the table T6 shown in FIG. 9A, it is found that the margin reduction amount for reducing the blank between the blocks B32 and B33, i.e., the margin reduction amount corresponding to the margin reduction position at the Y-coordinate “35”, is “14”. Thus, the processor 11 determines the resulting margin reduction amount “14”, which has been obtained by the addition of the margin reduction amount “14” and the first correction amount “0” as the corrected margin reduction amount corresponding to the margin reduction position at the Y-coordinate “35”.

When the combination of the attributes of the objects is a ruled line and a non-ruled line, the processor 11 performs margin reduction amount correction processing using a second correction amount (step S452). When the combination of the attributes of the objects is the ruled line and the non-ruled line, the second correction amount is applied to margin reduction processing for reducing the blank portion between these objects. Here, assume the case where the objects to be processed are the ruled line L2 and the block B32 shown in FIG. 9A. In this case, when referring to the table T7 shown in FIG. 9B, it is found that the second correction amount is “−1”. On the other hand, when referring to the table T6 shown in FIG. 9A, it is found that the margin reduction amount for reducing the blank between the ruled line L2 and the block B32, i.e., the margin reduction amount corresponding to the margin reduction position at the Y-coordinate “20” is “4”. Thus, the processor 11 determines the resulting margin reduction amount “3”, which has been obtained by the addition of the margin reduction amount “4” and the first correction amount “−1” as the corrected margin reduction amount corresponding to the margin reduction position at the Y-coordinate “20”. Note that, when the check box of the setting column 104 on the margin reduction setting screen shown in FIG. 6 described above is turned ON, the processor 11 performs margin reduction amount correction processing in which the thickness of the ruled line has been reflected. For example, assume the case where the objects to be processed are the ruled line L1 and the block B31 shown in FIG. 9A and the thickness of the ruled line L1 is “5”. In this case, the processor 11 determines “−3” as the second correction amount with reference to the table T7 shown in FIG. 9B. In other words, even if the combination of the attributes of the objects is the ruled line and the non-ruled line, when the check box of the setting column 104 shown in FIG. 6 is turned ON, the correction amount may differ depending on the thickness of the ruled line.

When the combination of the attributes of the objects is a ruled line and a ruled line, the processor 11 performs margin reduction amount correction processing using a third correction amount (step S453). When the combination of the attributes of the objects is a ruled line and a ruled line, the third correction amount is applied to margin reduction processing for reducing the blank portion between these objects. Here, assume the case where the objects to be processed are the ruled line L3 and the ruled line L4 shown in FIG. 9A. In this case, when referring to the table T7 shown in FIG. 9B, it is found that the third correction amount is “−3”. On the other hand, when referring to the table T6 shown in FIG. 9A, it is found that the margin reduction amount for reducing the blank between the ruled line L3 and the ruled line L4, i.e., the margin reduction amount corresponding to the margin reduction position at the Y-coordinate “80”, is “14”. Thus, the processor 11 determines the resulting margin reduction amount “11”, which has been obtained by the addition of the margin reduction amount “14” and the first correction amount “−3” as the corrected margin reduction amount corresponding to the margin reduction position at the Y-coordinate “80”. As a result of the processes in steps S451 to S453 described above, the corrected margin reduction amount corresponding to each margin reduction position is determined. The table T8 shown in FIG. 9C denotes the corrected margin reduction amounts, which are stored in a predetermined storage unit. Note that whether or not the margin reduction amounts are corrected depending on the combination of the objects may also be specified by a user on the setting screen shown in FIG. 6. When a user has not specified that the margin reduction amounts are corrected depending on the combination of the objects, margin reduction processing is applied to the objects other than the ruled line based on the margin reduction amounts that have been calculated in S445.

Next, the processor 11 determines a ruled line adjustment value for each of the vertical ruled lines and the horizontal ruled lines based on the corrected margin reduction amounts. The processor 11 stores the determined ruled line adjustment value in a predetermined storage unit. Then, the processor 11 updates an object take-out pointer (step S454), and the process returns to step S449 described above.

FIG. 11 is a diagram illustrating margin reduction processing according to the correction value obtained in step S455 shown in FIG. 10. First, the processor 11 determines whether or not there is a block having an object other than a ruled line (step S501). When the processor 11 determines that there is no block having an object other than a ruled line, the process advances to step S504. On the other hand, when the processor 11 determines that there is a block having an object other than a ruled line, the processor 11 extracts the block and extracts the corrected margin reduction amount from a predetermined storage unit (step S502). Then, the processor 11 performs margin reduction processing by modifying the block coordinate value using the extracted margin reduction amount (step S503), and the process returns to step S501.

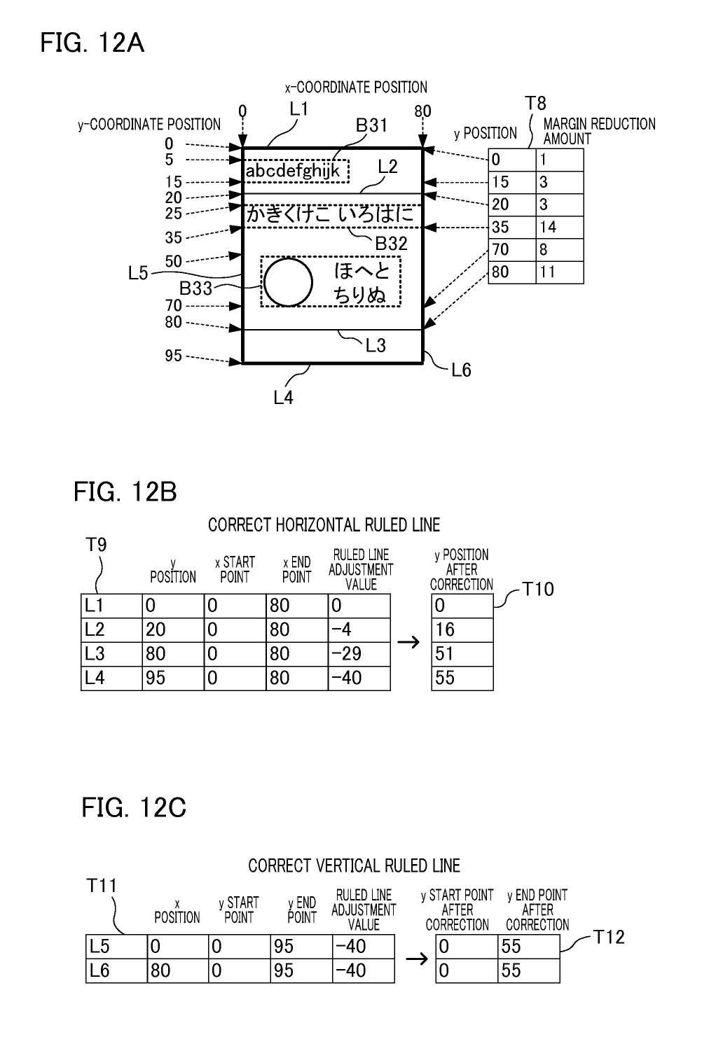

An example of modification processing for the block coordinate value in step S503 described above will now be described with reference to FIG. 12A. The processor 11 reduces the blank between blocks using the margin reduction amount that has been calculated by the described process with reference to FIG. 10. The table T8 shown in FIG. 12A is the same as the table TO shown in FIG. 9C. When referring to the table T8, it is found that the margin reduction amount for reducing the blank between the ruled line L1 and the block B31 is “1”. Thus, the processor 11 moves the block B31 upward by “1”. Also, for example, when referring to the table T8, the margin reduction amount for reducing the blank between the block B31 and the ruled line L2 is “3”, and the margin reduction amount for reducing the blank between the ruled line L2 and the block B32 is “3”. In other words, the margin reduction amount for reducing the blank between the blocks B31 and B32 is “6”. Thus, the processor 11 adds the executed margin reduction amount “1” to the aforementioned margin reduction amount “6” to thereby calculate “7” as the amount for moving the block B32 upward. Then, the processor 11 moves the block B32 upward by “7”. By means of the processes in steps S501 to S503 described above, margin reduction processing for blocks other than the ruled line is ended.

In step S504, the processor 11 determines whether or not there is a horizontal ruled line object (step S504). When the processor 11 determines that there is no horizontal ruled line object, the process advances to step S507. On the other hand, when the processor 11 determines that there is a horizontal ruled line object, the processor 11 extracts the horizontal ruled line object, and the process advances to step S505. Next, the processor 11 extracts the ruled line adjustment value corresponding to the horizontal ruled line indicated by the extracted horizontal ruled line object from a predetermined storage unit (step S505). Then, the processor 11 modifies the horizontal ruled line based on the extracted ruled line adjustment value (step S506), and the process returns to step S504.

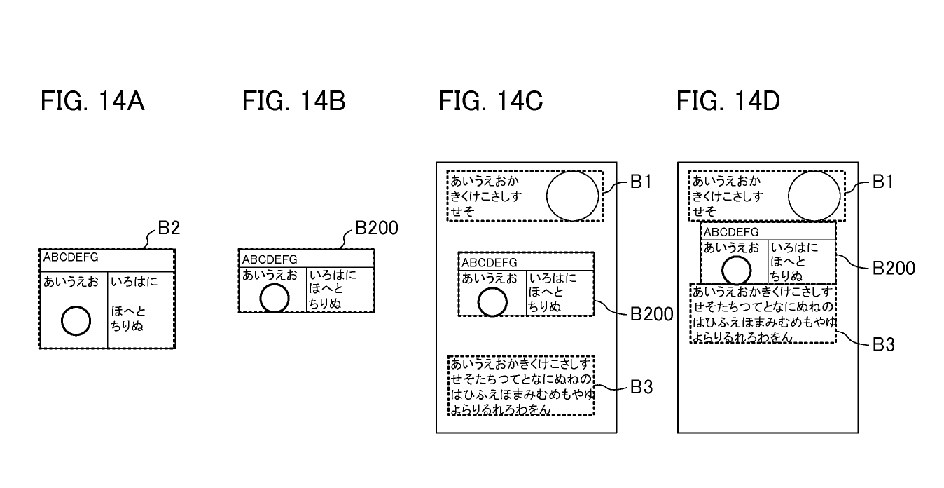

In step S507, the processor 11 determines whether or not there is a vertical ruled line object (step S507). When the processor 11 determines that there is a vertical ruled line object, the processor 11 extracts the vertical ruled line object, and the process advances to step S508. Next, the processor 11 extracts the ruled line adjustment value corresponding to the vertical ruled line indicated by the extracted vertical ruled line object from a predetermined storage unit (step S508). Then, the processor 11 modifies the vertical ruled line based on the extracted ruled line adjustment value (step S509), and the process returns to step S507. On the other hand, when the processor 11 determines that there is no vertical ruled line object, the process advances to step S510, and the processor 11 combines the ruled line object with the objects other than the ruled line (step S510). By means of margin reduction processing within a table block described with reference to FIGS. 10 to 12, for example, the table block B2 shown in FIG. 14A is modified to the table block B200 shown in FIG. 14B.

FIGS. 12B and 12C are diagrams illustrating ruled line correction processing. Note that the method for moving a ruled line is the same as that for blocks other than the ruled line. For example, when referring to the table T8 shown in FIG. 12A, the margin reduction amount for reducing the blank between the block B31 and the ruled line L2 is “3”. Thus, the ruled line L2 is moved upward by “4”, which is obtained by adding the executed margin reduction amount “1” to the margin reduction amount “3” for reducing the blank between the block B31 and the ruled line L2. In other words, the processor 11 sets the ruled line adjustment value corresponding to the ruled line L2 to “−4”. Then, the processor 11 corrects the Y-coordinate of the ruled line L2 from “20” to “16” based on the ruled line adjustment value. By executing the aforementioned process, the ruled lines L3 and L4 are moved upward by “29” and “40”, respectively. The table T9 shown in FIG. 12B denotes the ruled line adjustment values corresponding to the respective ruled lines. Also, the table T10 denotes the Y-coordinates of the corrected ruled lines based on the ruled line adjustment values.

Further, the processor 11 calculates the ruled line adjustment value “−40” for the ruled lines L5 and L6 based on the sum total of the margin reduction amounts shown in the table T8. The table T11 shown in FIG. 12C indicates the ruled line adjustment values for the ruled lines L5 and L6. The processor 11 calculates the coordinate “55” of the corrected y end points based on the coordinates of the original y end points (the end points of the ruled lines) of the ruled lines L5 and L6 and their ruled line adjustment values. The processor 11 does not correct the y start points (the start points of the ruled lines) of the ruled lines L5 and L6.

The table T12 denotes the corrected y start points and y end points of the ruled lines L5 and L6. The processor 11 corrects the ruled lines L5 and L6 based on the corrected y start points and y end points in the table T12. Consequently, the y end points of the ruled lines L5 and L6 are moved upward by “40”.

In the margin reduction processing within a table block described above, the processor 11 corrects the margin reduction amount based on the combination of the attributes of the adjacent objects among the objects included in the table block (steps S451 to S453 in FIG. 10). Then, the processor 11 executes margin reduction processing for the objects other than the ruled line object and correction of the ruled line indicated by the ruled line object using the corrected margin reduction amount (steps S501 to S509 in FIG. 11). Thus, according to the information processing apparatus of the present embodiment, margin reduction processing for the objects other than the ruled line object in accordance with the combination of the attributes of the adjacent objects among the objects included in the table block can be executed.

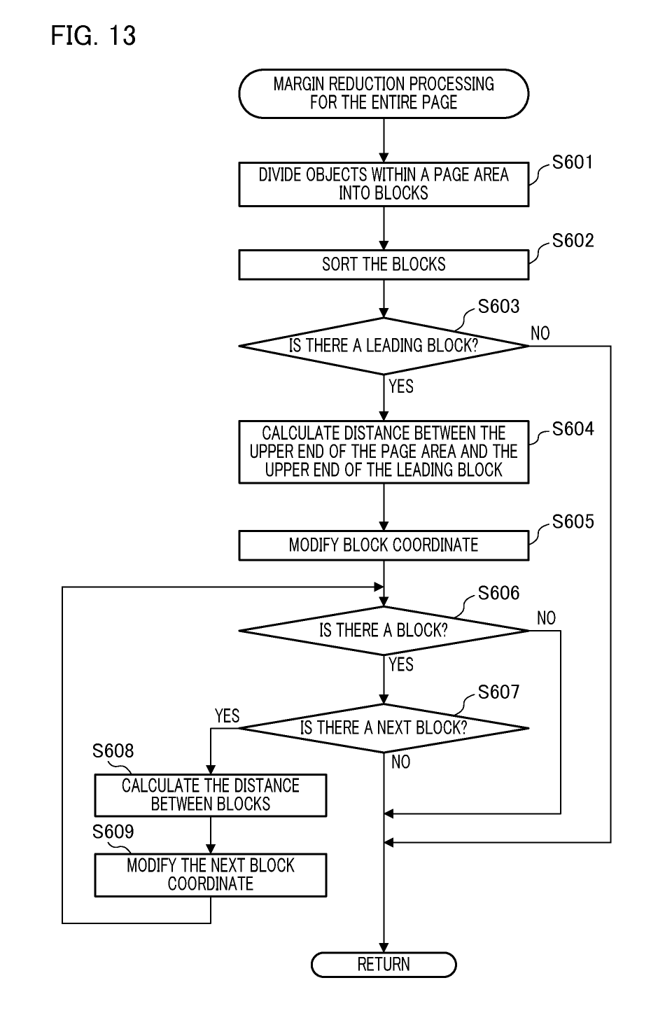

FIG. 13 is a diagram illustrating margin reduction processing for an entire page in step S45 shown in FIG. 7. Margin reduction processing for an entire page is executed for the modified table block of which the blank portion has been reduced by margin reduction processing within the table block in step S44 shown in FIG. 7 and for the blocks other than the table block among the blocks extracted in step S42 shown in FIG. 7. First, the processor 11 divides all objects within a page area into blocks (step S601). By means of the process in step S601, the objects within a page area is divided, for example, into three blocks B1 to B3 shown in FIG. 14C. The block B200 shown in FIG. 14C is the modified table block. The processor 11 updates the block information stored in the storage device 17. In other words, the processor 11 updates the information for the table block B2 prior to modification (see FIG. 14A) to the information corresponding to the table block B200. The processor 11 sorts the blocks in the ascending order of the Y-coordinates (step S602). Next, the processor 11 determines whether or not there is a leading block (step S603). When there is no leading block, the process advances to step S5 shown in FIG. 5. In contrast, when there is a leading block, the processor 11 takes out the leading block, and the process advances to step S604.

Next, the processor 11 calculates the distance between the upper end of the page area and the upper end of the leading block based on the Y-coordinate value of the upper end of the page area and the Y-coordinate value of the upper end of the leading block (step S604). Then, the processor 11 subtracts the calculated distance in step S604 from the Y-coordinate of the leading block to thereby modify the Y-coordinate of the leading block (step S605). For example, when the distance between the upper end of the page and the upper end of the leading block is a distance corresponding to 5 pixels, 5 pixels are subtracted from all of the Y-coordinates of the leading block. In other words, the distance denotes the size of the blank portion. The processor 11 subtracts the distance from the Y-coordinate of the leading block to thereby reduce the blank portion (to undergo margin reduction processing).

Next, the processor 11 determines whether or not there is any block to be extracted (step S606). Note that, since an extraction-completed flag is set in the block that has been extracted in S606, the processor 11 executes the process in step S606 using the extraction-completed flag. When there is no block to be extracted (when the extraction-completed flag is set in all blocks), the process advances to step S5 shown in FIG. 5. When there is a block to be extracted, the processor 11 extracts the block, and the process advances to step S607. When the block is first extracted by the process in step S607, the processor 11 extracts the leading block of which the Y-coordinate has been modified in step S605 described above. Next, the processor 11 determines whether or not there is a next block (step S607). When there is no next block, the process advances to step S5 shown in FIG. 5. When there is a next block, the processor 11 extracts the next block, and the process advances to step S608.

Next, the processor 11 calculates the distance (the size of the blank portion) between the block (first block) that has been extracted in step S606 and the block (second block) that has been extracted in step S607 (step S608). In step S608, the processor 11 calculates the distance between the first block and the second block based on the Y-coordinate of the lower end of the first block and the Y-coordinate of the upper end of the second block. The distance between the first block and the second block is reduced to a predetermined blank size obtained by execution of margin reduction processing. Then, the processor 11 subtracts the distance calculated in step S608 described above from the Y-coordinate of the second block to thereby modify the Y-coordinate of the second block, and the process returns to step S606. In other words, in margin reduction processing for an entire page, the processor 11 executes processing for reducing the blank portion between the adjacent blocks based on the coordinate of the table block to which margin reduction processing has been executed and the coordinates of the blocks other than the table block.

The processor 11 executes the aforementioned margin reduction processing for all blocks, which is performed for a page having, for example, three blocks as shown in FIG. 14C to thereby reduce the blank between blocks. Consequently, the margin of the page is reduced as shown in FIG. 14D, whereby unwanted prints can be reduced.

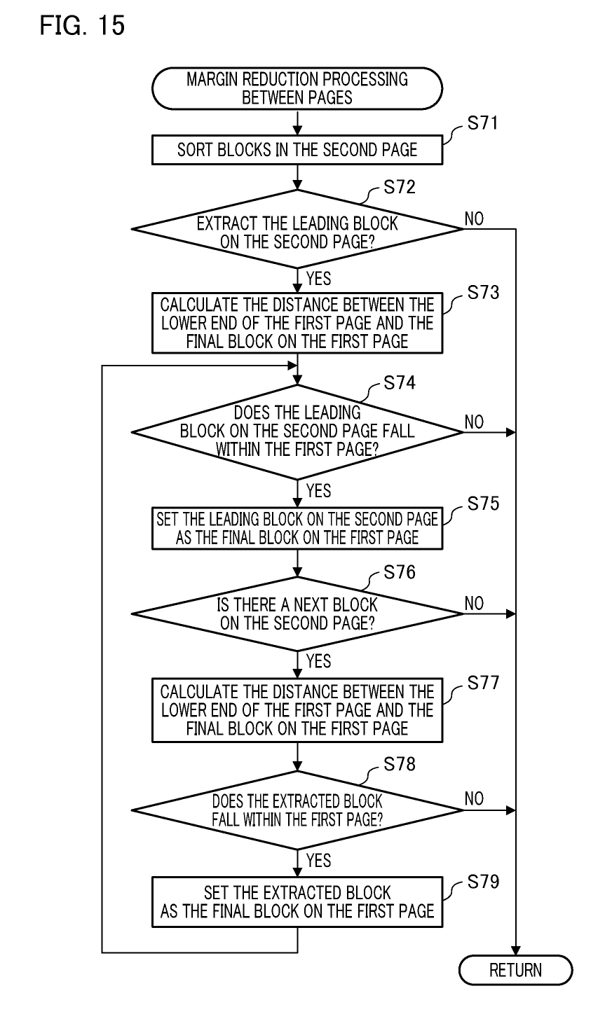

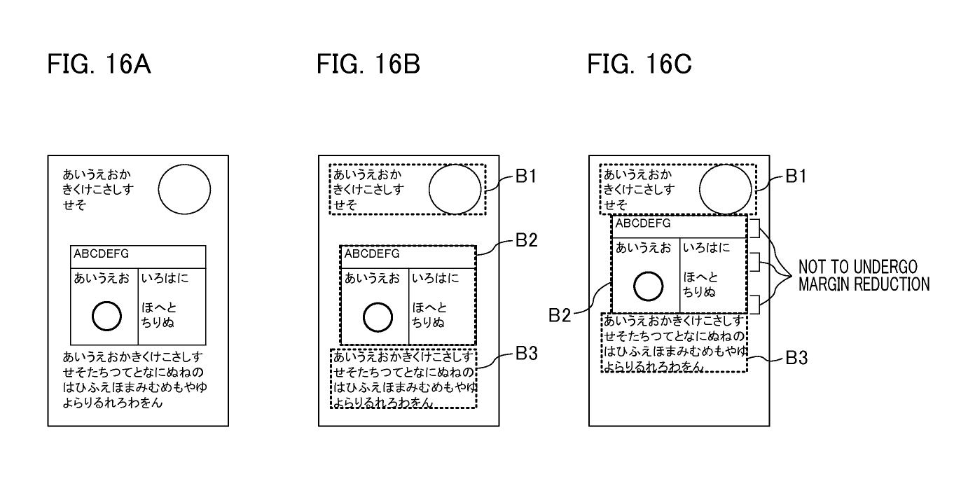

FIG. 15 is a diagram illustrating margin reduction processing between pages in step S7 shown in FIG. 5. In the following description, the first page and the second page are pages to which margin reduction processing for the entire page, i.e., processing for reducing the blank portion between blocks has been executed. The second page is the page next to the first page.

First, the processor 11 sorts the blocks within the second page, which is the page next to the first page, in an ascending order of the Y-coordinates (step S71). Next, the processor 11 determines whether or not there is a leading block on the second page (step S72). When there is no leading block on the second page, the process advances to step S8 shown in FIG. 5. When there is a leading block on the second page, the processor 11 extracts the leading block on the second page, and the process advances to step S73.

Next, the processor 11 calculates the distance between the lower end of the first page and the final block on the first page (step S73). Subsequently, the processor 11 determines whether or not the leading block on the second page falls within the first page (step S74). In step S74, the processor 11 calculates the width in the Y-axis direction of the leading block based on the coordinate of the leading block on the second page. Then, the processor 11 determines whether or not the size of the width of the block is less than the distance that has been calculated in step S73 described above. When the size of the width of the block is less than the distance that has been calculated in step S73 described above, the processor 11 determines that the block falls within the first page. When the size of the width of the block is equal to or greater than the distance that has been calculated in step S73 described above, the processor 11 determines that the block does not fall within the first page.

When the processor 11 determines that the leading block on the second page does not fall within the first page, the process advances to step S8 shown in FIG. 5. In contrast, when the processor 11 determines that the leading block on the second page falls within the second page, the processor 11 modifies the coordinates of the leading block on the second page to thereby set the block as the final block on the first page (step S75).

Subsequently, the processor 11 determines whether or not there is a next block on the second page (step S76). When there is no next block on the second page, the process advances to step S8 shown in FIG. 5. When there is a next block on the second page, the processor 11 extracts the block, and the process advances to step S77. Next, the processor 11 calculates the distance between the lower end of the first page and the final block on the first page (step S77). Subsequently, the processor 11 determines whether or not the extracted block in step S76 falls within the first page (step S78). When the processor 11 determines that the extracted block does not fall within the first page, the process advances to step S8 shown in FIG. 5. In contrast, when the processor 11 determines that the extracted block falls within the first page, the processor 11 modifies the coordinate of the extracted block to set the block as the final block on the first page (step S79), and the process returns to step S74. With this arrangement, the block included in the second page is laid out between the lower end of the final block on the first page and the lower end of the first page.

In other words, the processor 11 determines whether or not the block included in the second page falls within the first page based on the distance between the lower end of the final block included in the first page and the lower end of the first page and the coordinate of the block included in the second page. Then, the processor 11 places the block included in the second page between the lower end of the final block and the lower end of the first page based on the determined results. Thus, according to the information processing apparatus of the present embodiment, unwanted prints can be reduced for a plurality of entire pages to be printed. Note that the aforementioned margin reduction processing may be provided by the application stored in the information processing apparatus or may be provided by the printer driver stored therein.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-018437 filed Jan. 29, 2010, which is hereby incorporated by reference herein in its entirety.

What is claimed is:

1. An information processing apparatus comprising:
a division unit configured to divide objects laid out on a page into a plurality of blocks;
an extraction unit configured to extract a table block including a ruled line object from the plurality of blocks; and
a margin reduction unit configured to detect a blank portion between objects included in the extracted table block and execute margin reduction processing for reducing the detected blank portion.

2. The information processing apparatus according to claim 1, wherein the margin reduction unit extracts a ruled line object and objects other than the ruled line object from the extracted table block, executes margin reduction processing for reducing the margin of a blank portion between the objects other than the extracted ruled line object, corrects a ruled line indicated by the ruled line object based on the margin reduction processing result about the objects, which has been obtained by the executed margin reduction processing, other than the ruled line object, and combines the objects, which have undergone the margin reduction processing, other than the ruled line object with the corrected ruled line.

3. The information processing apparatus according to claim 2, wherein the margin reduction unit further executes margin reduction processing for the objects other than the ruled line object in accordance with a combination of attributes of the adjacent objects among the objects included in the table block.

4. The information processing apparatus according to claim 1,
wherein the extraction unit further extracts a block other than a table block from the plurality of blocks, and
wherein the margin reduction unit executes margin reduction processing for reducing the blank portion between adjacent blocks based on the coordinate of the table block that have undergone the margin reduction processing and the coordinate of the extracted block other than the table block.

5. The information processing apparatus according to claim 1, wherein the margin reduction unit determines whether or not a block included in a second page falls within a first page based on the distance between the lower end of the final block included in the first page and the lower end of the first page, on which processing for reducing the blank portion between the blocks has been executed, and the coordinate of the block included in the second page, which is the page next to the first page, and lays out the block included in the second page between the lower end of the final block and the lower end of the first page based on the determined results.

6. A method for controlling an information processing apparatus, the method comprising:
dividing objects laid out on a page into a plurality of blocks;
extracting a table block including a ruled line object from the plurality of blocks; and
detecting a blank portion between the objects included in the extracted table block and executing margin reduction processing for reducing the detected blank portion.

7. A storage medium storing a computer-readable program for causing a computer to execute a method for controlling an information processing apparatus, the program comprising:
dividing objects laid out on a page into a plurality of blocks;
extracting a table block including a ruled line object from the plurality of blocks; and
detecting a blank portion between the objects included in the extracted table block and executing margin reduction processing for reducing the detected blank portion.
